(19) United States
(12) Patent Application Publication
(10) Pub. No.: US 2025/0364857 A1
(43) Pub. Date: Nov. 27, 2025

(54) APPARATUS FOR SECURING A ROTOR CORE

(71) Applicant: Ford Global Technologies, LLC, Dearborn, MI (US)

(72) Inventors: Adam Bangerter, Dearborn, MI (US); Nicholas Hedrick, Garden City, MI (US)

(73) Assignee: Ford Global Technologies, LLC, Dearborn, MI (US)

(21) Appl. No.: 18/673,217

(22) Filed: May 23, 2024

(51) Int. Cl. H02K 1/28; H02K 1/276

(52) U.S. Cl. CPC H02K 1/28; H02K 1/276; H02K 2201/06

(57) ABSTRACT

An apparatus for securing a rotor core includes an upper plate and a lower plate. The lower plate is spaced apart from the upper plate and is configured to support the rotor core between the upper plate and the lower plate. The lower plate has an upper side facing in a first direction toward the upper plate and a lower side facing in a second direction away from the upper plate. The upper side includes a pocket recessed in the second direction relative to an upper surface of the upper side. The upper side includes a plurality of tabs configured to engage the rotor core and extending from an inner periphery of the lower plate into the pocket.

### FIELD

The present disclosure relates to an apparatus for securing a rotor core.

### BACKGROUND

The statements in this section merely provide background information related to the present disclosure and may not constitute prior art.

With the continuing electrification trend in motor vehicles, related components such as electric motors for electric vehicle powertrains are being developed for high volume production. These electric motors are complex assemblies, typically including a stator and a rotor made up of a plurality of rotor cores with a plurality of magnets disposed in pockets of the rotor cores.

Assembly of these electric motors can be time consuming and challenging given the complexity of the design of the rotor cores and their embedded magnets. Further, providing a secure connection between the plurality of magnets within the rotor core pockets while achieving assembly efficiency for high volume production can be difficult. Adhesive materials have been used to secure the magnets within the rotor core pockets, however, precisely controlling the volume of adhesive and its curing behavior has proven to be challenging.

These issues related to the manufacture of electric motors, including issues with securing magnets in rotor core pockets, are addressed by the present disclosure.

### SUMMARY

This section provides a general summary of the disclosure and is not a comprehensive disclosure of its full scope or all of its features.

In one form, the present disclosure provides an apparatus for securing a rotor including an upper plate and a lower plate. The lower plate is spaced apart from the upper plate and is configured to support the rotor core between the upper plate and the lower plate. The lower plate has an upper side facing in a first direction toward the upper plate and a lower side facing in a second direction away from the upper plate. The upper side includes a pocket recessed in the second direction relative to an upper surface of the upper side. The upper side includes a plurality of tabs configured to engage the rotor core and extending from an inner periphery of the lower plate into the pocket.

In variations of the apparatus of the above paragraph, which can be implemented individually or in any combination: a central mandrel extends between the upper plate and the lower plate and is configured to extend through the rotor core; the lower plate includes a plurality of openings extending therethrough, the openings are circumferentially spaced apart around the lower plate, and wherein the openings are located within the pocket; each tab includes a proximal end extending from the inner periphery of the lower plate and a distal end located within the pocket, and wherein the tab is tapered from the proximal end toward the distal end; the lower plate includes a plurality of openings extending therethrough, the openings are circumferentially spaced apart around the lower plate, and each tab includes a proximal end extending from the inner periphery of the lower plate and a distal end located between two openings of the plurality of openings; further including the rotor core, the rotor core including a plurality of stacked laminations secured to each other; the tabs have a triangular shape; and the tabs are positioned circumferentially around the upper side of the lower plate.

In another form, the present disclosure provides an apparatus for securing a rotor including an upper plate, a lower plate, and a rotor core. The lower plate is spaced apart from the upper plate and has an upper side facing in a first direction toward the upper plate and a lower side facing in a second direction away from the upper plate. The upper side includes a pocket recessed in the second direction relative to an upper surface of the upper side. The rotor core is located between the upper plate and the lower plate and engages the upper plate and the lower plate. The rotor core includes a plurality of cavities extending along an axial direction of the rotor core. Each cavity of the plurality of cavities extending from a first axial end of the rotor core to a second axial end of the rotor core and configured to receive a magnet insert. The lower plate includes a plurality of tabs engaging the rotor core and extending from an inner periphery of the lower plate into the pocket. Each tab of the plurality of tabs engaging the rotor core at a location beneath a respective cavity of the plurality of cavities to cover the respective cavity.

In variations of the apparatus of the above paragraph, which can be implemented individually or in any combination: a central mandrel extending between the upper plate and the lower plate and extending through the rotor core; the lower plate includes a plurality of openings extending therethrough, the openings are circumferentially spaced apart around the lower plate, and the openings are located within the pocket; each tab includes a proximal end extending from the inner periphery of the lower plate and a distal end located within the pocket, the tab is tapered from the proximal end toward the distal end; the lower plate includes a plurality of openings extending therethrough, the openings are circumferentially spaced apart around the lower plate, and each tab includes a proximal end extending from the inner periphery of the lower plate and a distal end located between two openings of the plurality of openings; the rotor core comprises a plurality of stacked laminations secured to each other; each tab has a triangular shape; the tabs are positioned circumferentially around the upper side of the lower plate; and the plurality of cavities are formed near an outer periphery of the rotor core.

In yet another form, the present disclosure provides an apparatus for securing a rotor including an upper plate, a lower plate, a rotor core, and a central mandrel. The lower plate is spaced apart from the upper plate and has an upper side facing in a first direction toward the upper plate and a lower side facing in a second direction away from the upper plate. The upper side includes a pocket recessed in the second direction relative to an upper surface of the upper side. The rotor core is located between the upper plate and the lower plate and engages the upper plate and the lower plate. The rotor core includes a stack of laminations secured to each other. Each lamination of the stack of laminations includes a plurality of circumferentially spaced apart cavities extending from a first axial end of the lamination to a second axial end of the lamination and is configured to receive a magnet insert. The central mandrel extending between the upper plate and the lower plate and extending through the rotor core. The lower plate includes a plurality of tabs engaging a lowermost lamination of the stack of laminations and extending from an inner periphery of the lower plate into the pocket. Each tab engaging the lowermost lamination at a location beneath a respective cavity of the plurality of cavities to cover the respective cavity.

In variations of the apparatus of the above paragraph, which can be implemented individually or in any combination: the circumferentially spaced apart cavities of a first lamination are rotationally offset relative to respective circumferentially spaced apart cavities of an adjacent second lamination and the circumferentially spaced apart cavities of the first lamination are fluidly coupled to the respective circumferentially spaced apart cavities of the adjacent second lamination.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a perspective view of an electric converter manufactured according to the teaching of the present disclosure;

FIG. 1B is an exploded view of a rotor core and magnetizable inserts of the electric converter of FIG. 1A;

FIG. 2 is a schematic cross-sectional view of an apparatus for securing magnetizable inserts within rotor cores of an electric converter according to the teachings of the present disclosure;

FIG. 3 is a perspective view of a portion of the apparatus of FIG. 2 including an upper tool, a lower tool, and a stack of rotor cores;

FIG. 4 is a bottom perspective view of a portion of the apparatus of FIG. 2 including the upper tool and the lower tool;

FIG. 5 is a perspective view of the lower tool of the apparatus of FIG. 2;

FIG. 6 is a cross-sectional view of the apparatus taken along line 6-6 of FIG. 3;

FIG. 7 is a bottom perspective view of the portion of the apparatus of FIG. 2 including the upper tool, the lower tool, and the stack of rotor cores;

FIG. 8 is a cross-sectional view of the portion of the apparatus of FIG. 2 including the upper tool, the lower tool, and the stack of rotor cores and illustrating flow paths for the molten polymer and airflow according to the principles of the present disclosure;

FIG. 9 is a flow diagram illustrating a method of securing magnetizable inserts within rotor cores of an electric converter according to the principles of the present disclosure;

FIG. 10A is a perspective view of a stack of rotor cores having magnetizable inserts secured within their cavities after a molding process according to the teachings of the present disclosure; and

FIG. 10B is an enlarged view of a portion of the stack of rotor cores of FIG. 10A.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

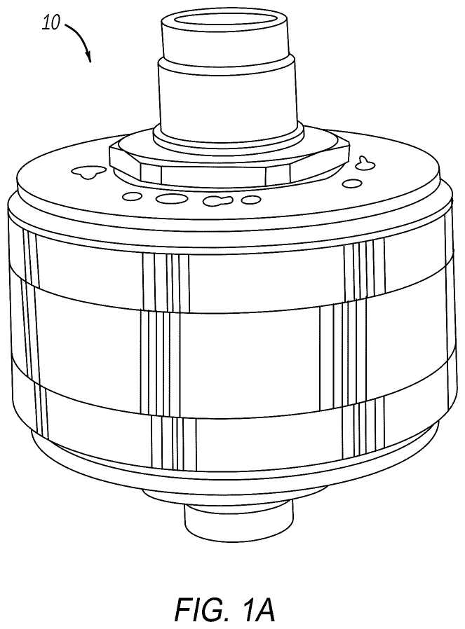

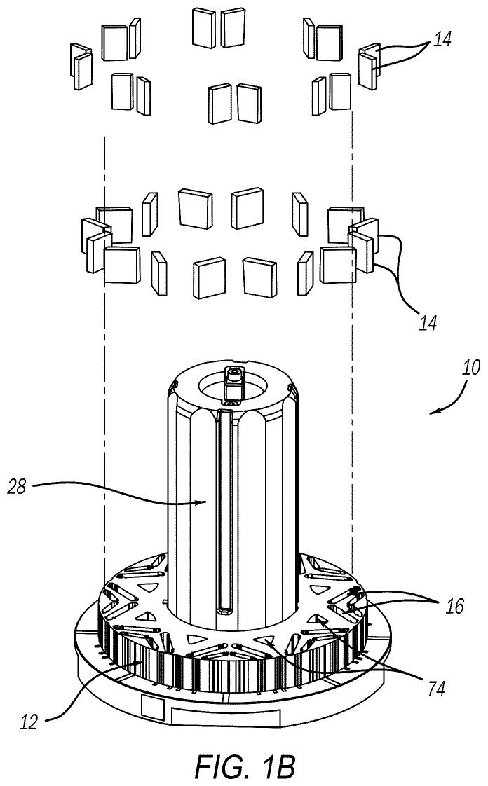

With reference to FIGS. 1A and 1B, an electric converter is provided and is generally indicated by reference numeral 10. The electric converter 10 includes a stack of rotor cores 12 and a plurality of magnetizable inserts 14 disposed within cavities 16 of the rotor cores 12. The cavities 16 of each rotor core 12 are circumferentially spaced apart around the rotor core 12 and are in fluid communication with the cavities 16 of other rotor cores 12 of the stack of rotor cores 12. For example, the cavities 16 of one of the rotor cores 12 are in fluid communication with the cavities 16 of an adjacent rotor core 12. In this way, the cavities 16 of the rotor cores 12 are in fluid communication with each other along an axial direction of the electric converter 10 such that adhesive material can flow through each of the cavities 16 during the molding process as described in greater detail below. In the example illustrated, the cavities 16 of one of the rotor cores 12 are rotationally offset or misaligned relative to the cavities 16 of an adjacent rotor core 12. In some forms, the cavities 16 of the rotor cores 12 may be rotationally aligned with the cavities 16 of an adjacent rotor 12. Each rotor core 12 may be formed by a stack of laminations (not specifically shown) secured to each other. Each lamination of the stack of laminations may include a plurality of circumferentially spaced apart cavities extending from a first axial end of the lamination to a second axial end of the lamination. The cavities of the stack of laminations form the cavities 16 of the rotor cores 12 when the laminations are stacked on each other. An example construction of an electric converter including the rotor cores is described in detail in U.S. Publication No. 2018/0287439, which has been incorporated herein by reference in its entirety.

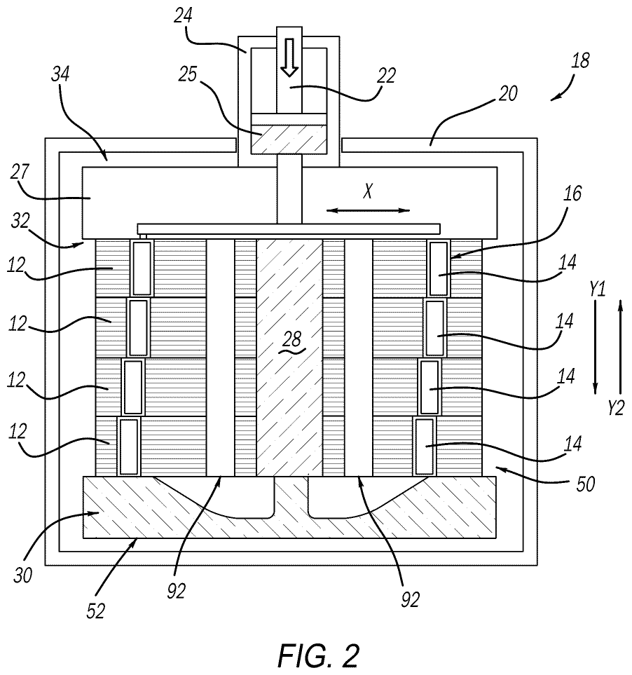

With reference to FIG. 2, an apparatus 18 for securing the magnetizable inserts 14 within the rotor cores 12 is provided. The apparatus 18 is disposed within a transfer molding press 20, which includes a plunger 22 disposed within the housing 24. The plunger 22 functions to displace the adhesive, which in one form is a polymer preform 25 during molding. The polymer preform 25 generally defines a cylindrical geometry or a puck-like shape before molding. However, it should be understood that other geometries may be employed while remaining within the scope of the present disclosure. In one form, the polymer preform 25 is a thermoset material such as an epoxy, for example. It should be understood that other types of thermoset materials or polymer materials (e.g., thermoplastics) may be employed while remaining within the scope of the present disclosure.

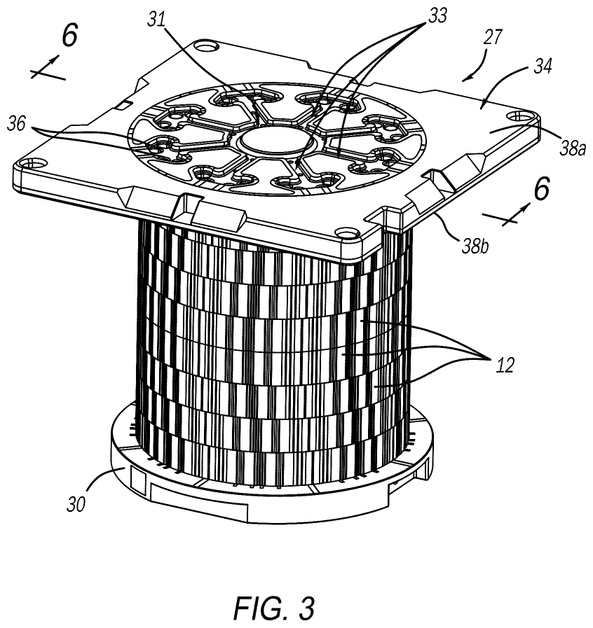

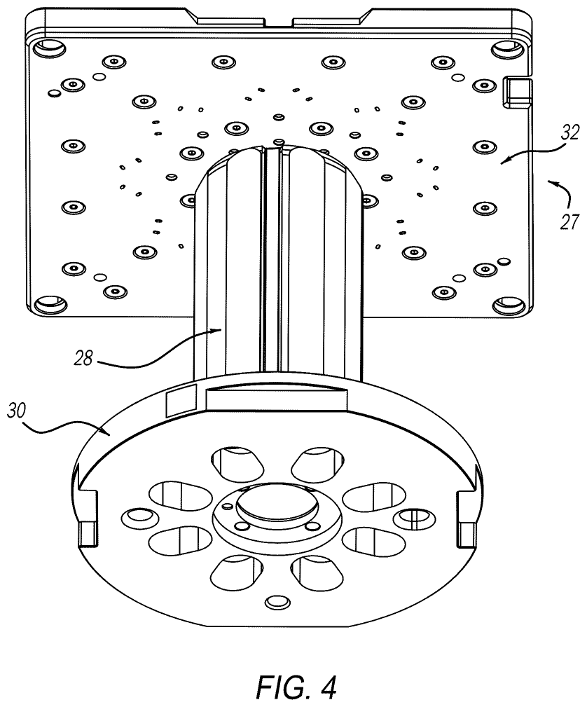

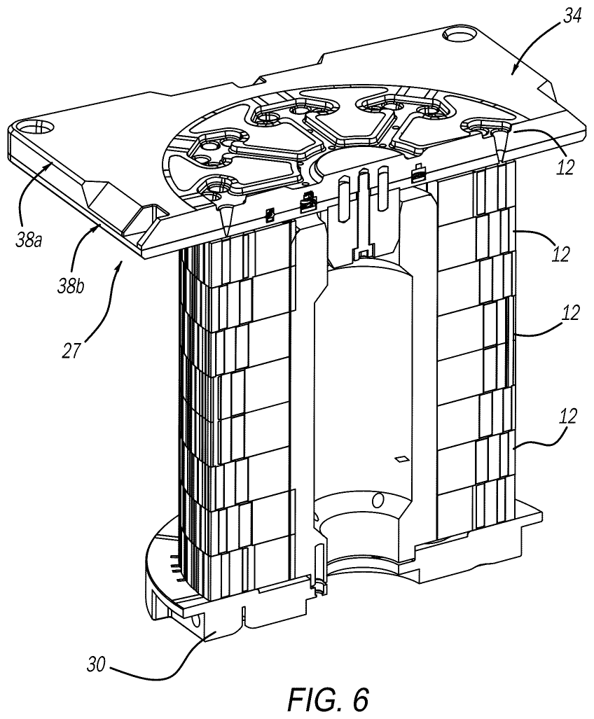

The apparatus 18 includes an upper tool or upper plate 27, the stack of rotor cores 12, a central mandrel 28, and a lower tool or lower plate 30. With reference to FIGS. 2-6, the upper tool 27 includes a lower side 32 that faces in a first direction Y1 towards the lower plate 30 and an upper side 34 that faces in a second opposite direction Y2 away from the lower plate 30. With reference to FIG. 3, the upper tool 27 includes a runner cavity 31, a plurality of runners or slots 33, and a plurality of gates 36. The runner cavity 31 and the runners 33 are both formed along the upper side 34 of the upper tool 27. In the example illustrated, the runner cavity 31 is formed at or near a central area of the upper side 34 of the upper tool 27 and the runners 33 extend in a radial direction X to connect the runner cavity 31 to the gates 36. The gates 36 extend from the runners 33 to the cavities 16 of the rotor cores 12. The runners 33 and the gates 36 direct a flow of the adhesive in the liquid state through the apparatus 18 during the molding process as will be described in more detail below.

In the example illustrated, the upper tool 27 is formed of an upper plate 38a and a lower plate 38b secured to the upper plate 38a using mechanical fasteners, adhesives, or another other suitable attachment means. The upper plate 38a includes the runner cavity 31, the runners 33 and an upper portion of the gates 36 while the lower plate 38b includes a lower portion of the gates 36. In some forms, the upper tool 27 may be formed of a single plate including the runner cavity 31, the runners 33 and the gates 36.

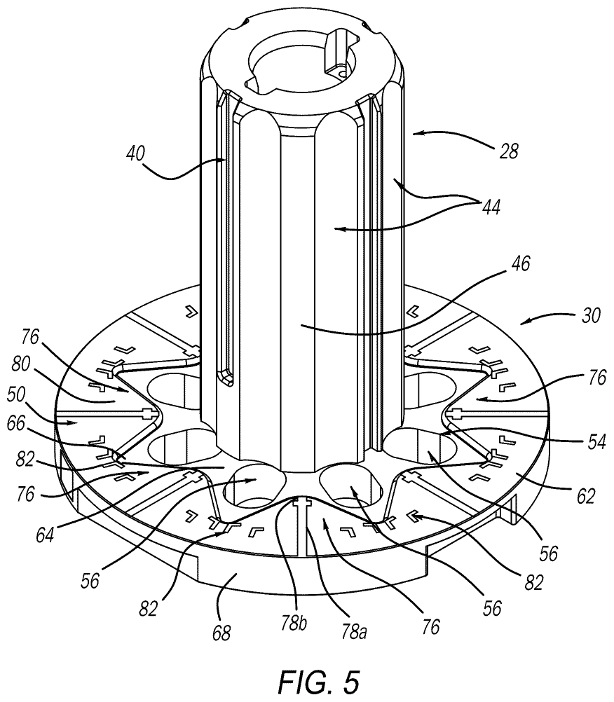

The central mandrel 28 extends between the upper tool 27 and the lower tool 30 and extends through a center of the stack of rotor cores 12. In the example illustrated, the central mandrel 28 includes keyways or grooves 40 (FIG. 5), which mate with tabs (not specifically shown) of the rotor cores 12 to properly locate and align the rotor cores 12 within the apparatus 18. In the example illustrated, the central mandrel 28 also includes a series of cutouts 44 (FIG. 5) and ridges 46 (FIG. 5) extending circumferentially around the central mandrel 28. The ridges 46 provide reduced contact area with the rotor cores 12, thus, reducing friction when removing the rotor cores 12 from the lower tool 30 and the central mandrel 28 after the molding process.

The lower plate 30 is spaced apart from the upper plate 27 and supports the rotor cores 12 such that the rotor cores 12 are sandwiched between the upper plate 27 and the lower plate 30. In the example illustrated, the lower plate 30 has an annular shape. In some forms, the lower plate 30 may have a rectangular shape, a square shape, or any other suitable shape that may support the rotor cores 12. The lower plate 30 has an upper side 50 facing in the second direction Y2 toward the upper plate 27 and a lower side 52 facing in the first direction Y1 away from the upper plate 27.

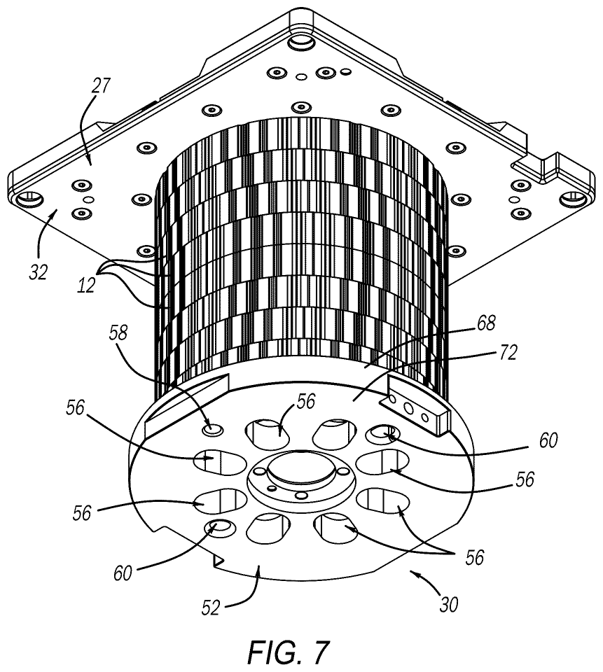

With reference to FIGS. 5 and 7, the lower plate 30 includes a pocket 54 (FIG. 5), a plurality of openings 56, one or more tool openings 58 (FIG. 7), and a plurality of locating apertures 60 (FIG. 7). The pocket 54 is formed at or near a center area of the lower plate 30 and is recessed in the first direction Y1 relative to an upper surface 62 of the upper side 50 so that the pocket 54 defines an intermediate surface 64 that is spaced apart from the upper surface 62 and the rotor cores 12. The pocket 54 may surround the central mandrel 28 and may define an inner periphery 66 that is spaced apart from an outer periphery 68 of the lower plate 30. In one form, the inner periphery 66 may have a pointed edge. In another form, the inner periphery 66 may have a chamfered edge. In yet another form, an edge of the inner periphery 66 may be contoured.

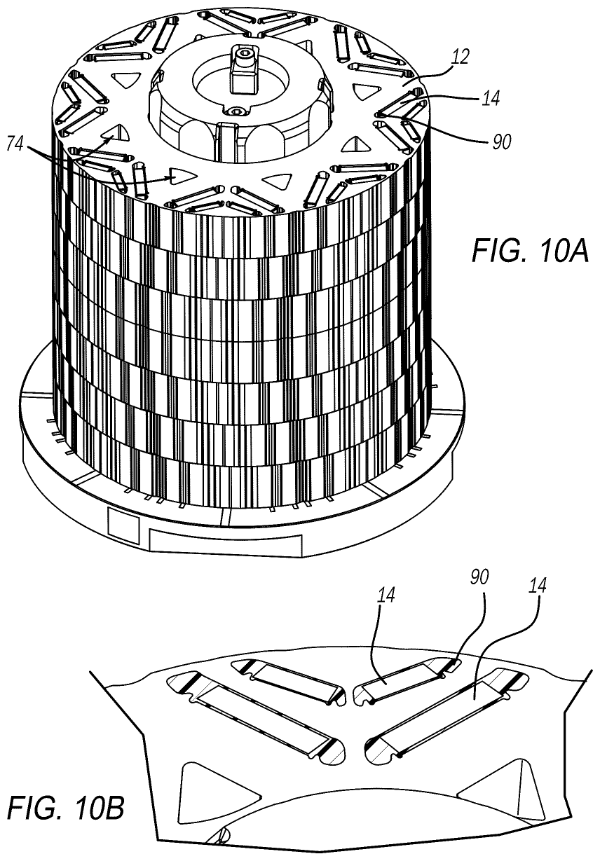

The openings 56 are circumferentially spaced apart around the lower plate 30 and are located within the pocket 54. That is, the openings 56 extend from a lower surface 72 of the lower plate 30 to the intermediate surface 64 of the pocket 54. The openings 56 are in fluid communication with openings 74 (FIGS. 1B and 10A) formed in the rotor cores 12 to provide heating channels or a conduit for airflow during the molding process. The tool openings 58 may extend partially through the lower plate 30 and may be used for inserting a tool (not shown) to remove or push the rotor cores 12 off of the central mandrel 28 and the lower plate 30. The locating apertures 60 are formed in the lower surface 72 of the lower plate 30 and interface with features (not shown) of the transfer molding press 20 to locate the lower plate 30 for the molding process.

The lower plate 30 further includes a plurality of tabs 76 located at the upper side 50 of the lower plate 30 and engaging the lowermost rotor core 12. Stated differently, the tabs 76 are circumferentially spaced apart around the inner periphery 66 of the lower plate 30 and cover respective cavities 16 of the rotor cores 12. In the example illustrated, the tabs 76 have a triangular shape. In some forms, the tabs 76 may include a semicircular shape or any other suitable shape that may support the rotor cores 12 and cover the cavities 16 of the rotor cores 12. In the example illustrated, each tab 76 extends from the inner periphery 66 into the pocket 54 and includes an upper surface 80 that is coplanar with the upper surface 62 of the lower plate 30. Each tab 76 is disposed between the inner periphery 66 and the openings 56 and includes a proximal end 78a and a distal end 78b. The proximal end 78a extends from the inner periphery 66 of the lower plate 30 and the distal end 78b is located within the pocket 54 between two openings 56 of the plurality of openings 56. The tab 76 is tapered from the proximal end 78a toward the distal end 78b.

Each tab 76 of the plurality of tabs 76 is spaced apart from the central mandrel 28. The lower plate 30 also includes vent openings 82 formed on the upper surface 80 and/or the tabs 76. The vent openings 82 provide vents for air to escape the apparatus 18 during the molding process.

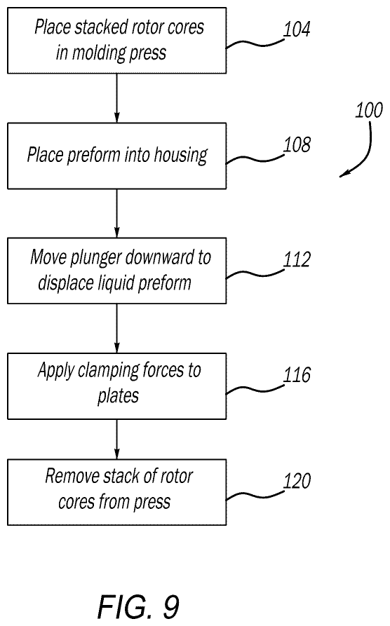

With reference to FIG. 9, a method 100 for securing the magnetizable inserts 14 within the rotor cores 12 is provided. At 104, the method includes placing the stack of rotor cores 12 in the transferring molding press 20. The stack of rotor cores 12 may be secured to each other using an attachment feature 92 (FIG. 2) prior to being placed in the transferring molding press 20. In one form, the attachment feature 92 is an adhesive that is placed between laminations (not specifically shown) of each rotor core 12 of the stack of rotor cores 12 to secure the laminations and adjacent rotor cores 12 to each other. In another form, the attachment feature 92 is an interlock located between laminations of each rotor core 12 of the stack of rotor cores 12 to secure the laminations and adjacent rotor cores 12 to each other. In the example illustrated, the attachment features 92 secure the laminations of the stack of rotor cores 12 and the adjacent rotor cores 12 to each other at a location inward of the cavities 16 containing the magnetizable inserts 14. The magnetizable inserts 14 are disposed within the cavities 16 of the rotor cores 12 prior to the stack of rotor cores 12 being placed in the transferring molding press 20. In some forms, the stack of rotor cores 12 and the polymer preform 25 may be preheated prior to placing the stack of rotor cores 12 in the transfer molding press 20. In another form, an assembly including the stack of rotor cores 12, the lower tool 30, the central mandrel 28, and/or the upper tool 27 may be preheated before being placed into the molding press 20.

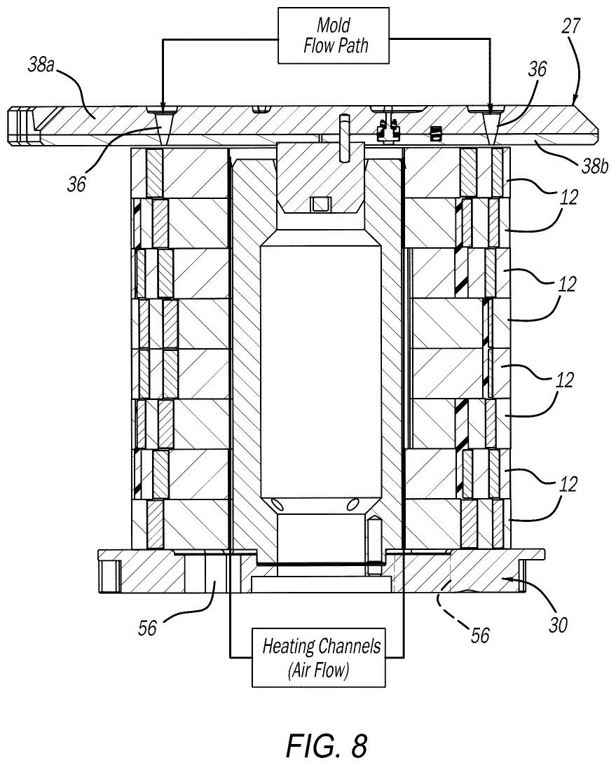

At 108, the polymer preform 25 is placed in the housing 24, below the plunger 22 of the transfer molding press 20 and proximate the stack of rotor cores 12. Alternately, the polymer preform 25 may be placed on top of the upper tool 27 prior to molding. At 112, within the transfer molding press 20, heat and a transfer pressure are applied, and the plunger 22 moves downward to displace the polymer preform 25 such that the polymer preform 25 changes state (i.e., changes from a solid state to a liquid state) and flows from the runner cavity 31 through the runners 34, through the gates 36, and subsequently through the cavities 16 of the rotor cores 12. As shown in FIG. 8, the upper tool 27, the lower tool 30, and the stack of rotor cores 12 are shown to illustrate flow paths of the molten polymer and air flow through the stack of rotors 12 during the molding process. The openings 56 of the lower plate 30 are in fluid communication with openings 74 formed in the rotor cores 12 to provide heating channels or a conduit for airflow during the molding process.

At 116, a clamping force is provided by the transfer molding press 20 to the upper tool 27 and the lower tool 30, which may vary in magnitude depending on the number and size of rotor cores 12 and the volume of the cavities 16 being filled by the liquid polymer preform 25. In one form, the lower tool 30 is spring loaded in order to apply additional forces when clamping. The clamping force continues to be provided within the transfer molding press 20 for a predetermined period of time or a cure time after all of the liquid polymer preform 25 has been pressed by the plunger 22. In one example, the cure time is 120 seconds for a liquid polymer preform. The transfer pressure (applied by the plunger 22) is also a function of the volume of the cavities 16 being filled by the liquid polymer preform 25.

At 120, after the cavities 16 have been filled by the liquid polymer preform 25, and after the predetermined period of time for curing, the stack of rotor cores 12 are removed from the transfer molding press 20. Referring to FIGS. 10A and 10B, the completed stack of rotor cores 12 are illustrated with magnetizable inserts 14 being secured within the cavities 16 by a cured polymer material 90. That is, the polymer material 90 has cured around the magnetizable inserts 14, thus forming a bond between the magnetizable inserts 14 and the rotor cores 12.

The present disclosure provides an apparatus 18 including a lower tool 30 for securing a stack of rotor cores 12 during a molding process. The lower tool 30 includes the pocket 54 and the plurality of tabs 76, which cooperate to direct the clamping load path of the plates 27, 30 at a location of the cavities 16 of the stack of rotor cores 12 (i.e., at or near an outer periphery of the stack of rotor cores 12) rather than around the attachment features 92 located near an inner periphery of the stack of rotor cores 12. That is, the clamping load of the plates 27, 30 is directed at the tabs 76 covering the respective cavities 16 of the stack of rotor cores 12. This load is directed around the cavities 16 of the stack of rotor cores 12 facilitates the clamping function during the molding process and reduces the epoxy being forced out of a periphery of the stack of rotor cores 12, for example, during the molding process.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An apparatus for securing a rotor core, the apparatus comprising:
an upper plate; and
a lower plate spaced apart from the upper plate and configured to support the rotor core between the upper plate and the lower plate, the lower plate having an upper side facing in a first direction toward the upper plate and a lower side facing in a second direction away from the upper plate, the upper side comprising a pocket recessed in the second direction relative to an upper surface of the upper side, wherein the upper side comprises a plurality of tabs configured to engage the rotor core and extending from an inner periphery of the lower plate into the pocket.

2. The apparatus of claim 1, further comprising a central mandrel extending between the upper plate and the lower plate and configured to extend through the rotor core.

3. The apparatus of claim 1, wherein the lower plate includes a plurality of openings extending therethrough, the openings are circumferentially spaced apart around the lower plate, and wherein the openings are located within the pocket.

4. The apparatus of claim 1, wherein each tab includes a proximal end extending from the inner periphery of the lower plate and a distal end located within the pocket, and wherein the tab is tapered from the proximal end toward the distal end.

5. The apparatus of claim 1, wherein:
the lower plate includes a plurality of openings extending therethrough, the openings are circumferentially spaced apart around the lower plate, and
each tab includes a proximal end extending from the inner periphery of the lower plate and a distal end located between two openings of the plurality of openings.

6. The apparatus of claim 1, further comprising the rotor core, the rotor core comprising a plurality of stacked laminations secured to each other.

7. The apparatus of claim 1, wherein the tabs have a triangular shape.

8. The apparatus of claim 1, wherein the tabs are positioned circumferentially around the upper side of the lower plate.

9. An apparatus comprising:
an upper plate;
a lower plate spaced apart from the upper plate and having an upper side facing in a first direction toward the upper plate and a lower side facing in a second direction away from the upper plate, the upper side comprising a pocket recessed in the second direction relative to an upper surface of the upper side; and
a rotor core located between the upper plate and the lower plate and engaging the upper plate and the lower plate, the rotor core comprising a plurality of cavities extending along an axial direction of the rotor core, each cavity of the plurality of cavities extending from a first axial end of the rotor core to a second axial end of the rotor core and configured to receive a magnet insert,
wherein the lower plate comprises a plurality of tabs engaging the rotor core and extending from an inner periphery of the lower plate into the pocket, each tab of the plurality of tabs engaging the rotor core at a location beneath a respective cavity of the plurality of cavities to cover the respective cavity.

10. The apparatus of claim 9, further comprising a central mandrel extending between the upper plate and the lower plate and extending through the rotor core.

11. The apparatus of claim 9, wherein the lower plate includes a plurality of openings extending therethrough, the openings are circumferentially spaced apart around the lower plate, and wherein the openings are located within the pocket.

12. The apparatus of claim 9, wherein each tab includes a proximal end extending from the inner periphery of the lower plate and a distal end located within the pocket, and wherein the tab is tapered from the proximal end toward the distal end.

13. The apparatus of claim 9, wherein:
the lower plate includes a plurality of openings extending therethrough, the openings are circumferentially spaced apart around the lower plate, and
each tab includes a proximal end extending from the inner periphery of the lower plate and a distal end located between two openings of the plurality of openings.

14. The apparatus of claim 9, wherein the rotor core comprises a plurality of stacked laminations secured to each other.

15. The apparatus of claim 9, wherein each tab has a triangular shape.

16. The apparatus of claim 9, wherein the tabs are positioned circumferentially around the upper side of the lower plate.

17. The apparatus of claim 9, wherein the plurality of cavities are formed near an outer periphery of the rotor core.

18. An apparatus comprising:
an upper plate;
a lower plate spaced apart from the upper plate and having an upper side facing in a first direction toward the upper plate and a lower side facing in a second direction away from the upper plate, the upper side comprising a pocket recessed in the second direction relative to an upper surface of the upper side;
a rotor core located between the upper plate and the lower plate and engaging the upper plate and the lower plate, the rotor core comprising a stack of laminations secured to each other, each lamination of the stack of laminations includes a plurality of circumferentially spaced apart cavities extending from a first axial end of the lamination to a second axial end of the lamination and is configured to receive a magnet insert; and
a central mandrel extending between the upper plate and the lower plate and extending through the rotor core,
wherein the lower plate comprises a plurality of tabs engaging a lowermost lamination of the stack of laminations and extending from an inner periphery of the lower plate into the pocket, each tab engaging the lowermost lamination at a location beneath a respective cavity of the plurality of cavities to cover the respective cavity.

19. The apparatus of claim 18, wherein the circumferentially spaced apart cavities of a first lamination are rotationally offset relative to respective circumferentially spaced apart cavities of an adjacent second lamination.

20. The apparatus of claim 19, wherein the circumferentially spaced apart cavities of the first lamination are fluidly coupled to the respective circumferentially spaced apart cavities of the adjacent second lamination.
